(19) United States
(12) Patent Application Publication
(10) Pub. No.: US 2008/0258908 A1
(43) Pub. Date: Oct. 23, 2008

(54) Systems and Methods for Communications Activity Status

(75) Inventor: Nils Graef, Santa Clara, CA (US)

Correspondence Address: Hamilton,DeSanctis & Cha, 8555 W. BELLEVIEW AVE. G21-139, LITTLETON, CO, 80123, US

(73) Assignee: LSI Corporation, Milipitas, CA (US)

(21) Appl. No.: 11/738,626

(22) Filed: Apr. 23, 2007

(51) Int. Cl. G08B 5/18; H04Q 7/00

(52) U.S. Cl. 340/539.13

(57) ABSTRACT

Various systems and methods for indicating the status of a communication are disclosed herein. For example, status indication methods are disclosed that include initiating a communication that allows for communication between two persons. Further, the methods include determining a combination of status. The combination of status is based on a determination of two or more of the following: a calendar status, a power status, an activity status, and a location status. A communication status message is updated based at least in part on the determined combination of status.

### BACKGROUND OF THE INVENTION

The present invention is related to communication systems, and more particularly to systems and methods for indicating the status of one or more communicators interacting in a communication.

Different approaches to communications exist and new approaches continue to be introduced. Not many years ago, communications consisted of PSTN telephone calls and physical mail communications. In contrast, today a communication may be accomplished using email, cellular telephones, voice over IP communications, video conferencing, and a number of combinations of the aforementioned communications approaches. In addition, some of the recently developed communications approaches allow a communicator to communicate using a mobile device. The myriad of communications approaches and mobility of communications have greatly enhanced the ability to communicate one with another.

Unfortunately, the myriad of approaches are not as stable as earlier communications systems. This instability has led to a great deal of miscommunication where one party (i.e., communicator) participating in the communication misinterprets a loss of communication ability by another party (i.e., communicator) as the other party's desire to suddenly stop communications. This has and continues to lead to very unfortunate circumstances and misunderstandings.

Internet messengers and voice over IP services have attempted to address the aforementioned situation by allowing a user to manually indicate their status by selecting between one of various available status messages. However, these messages are often inadequate, the party setting the message often forgets, and/or the party setting the message is rendered incapable of communicating before the message is set. One more progressive service, Skype™, has even gone so far as to sense keyboard and mouse activity. While this may to some degree overcome the forgetfulness of the party communicating, it fails to address the various other situations where an appropriate status message is not set.

Hence, for at least the aforementioned reasons, there exists a need in the art for advanced systems and methods for indicating communication status.

### BRIEF SUMMARY OF THE INVENTION

The present invention is related to communication systems, and more particularly to systems and methods for indicating the status of one or more communicators interacting in a communication.

Various systems and methods for indicating the status of a communication are disclosed herein. For example, some embodiments of the present invention provide Internet communication systems. Such systems include a computer readable medium that maintains instructions executable by a processor to receive a first communication message directed to a communicator, and to send a second communication message from the communicator. Further, the computer readable medium includes instructions executable by the processor to determine a combination of status. The combination of status includes a determination of at least two of a calendar status, a power status, an activity status, and a location status. Based at least in part on the combination of status, a communication status message is updated. In some cases, the communication status message is available to a recipient of the sent communication. In various instances, one or more of the above mentioned communication messages may be a text message, a voice message, a video message or some combination thereof. In one or more cases determining the combination of status includes a determination of at least three of the aforementioned status, while in other cases it includes a determination of all of the aforementioned status.

Other embodiments of the present invention provide status indication methods that include initiating a communication that allows for communication between two communicators. Further, the methods include determining a combination of status. The combination of status is based on a determination of two or more of the following: a calendar status, a power status, an activity status, and a location status. A communication status message is updated based at least in part on the determined combination of status. In some instances, determination of the aforementioned calendar status includes accessing an electronic calendar that indicates a schedule of one of the communicators, and identifying an event on the calendar that conflicts with the communication. In various instances, determination of the aforementioned power status includes projecting a time when power to a device used by the first communicator to communicate will be limited to the extent that the communication will not be sustainable, and indicating a power status based at least in part on the projected time. In one or more instances, the aforementioned determination of the activity status includes determining whether at least one of a mouse, a keyboard, and a camera indicate that the communicator is still available.

Yet other embodiments of the present invention provide communication status identification systems. The systems include a processor and a computer readable medium. The computer readable medium includes instructions executable by the processor to initiate a communication that allows at least a first communicator and a second communicator to communicate. The computer readable medium further includes instructions executable by the processor to determine a combination of status. The combination of status includes a determination of at least two of a calendar status, a power status, an activity status, and a location status. Based at least in part on the combination of status, a communication status message is updated.

In some instances of the aforementioned embodiments, the determination of the calendar status includes accessing instructions from the computer readable medium that are executable to access an electronic calendar that indicates a schedule of the first communicator; and to identify an event on the calendar that conflicts with the communication. In some cases, the event may be a present conflict or a future conflict. In such cases a future conflict may be an event that is scheduled to occur within a programmed time limit in the future.

In other instances of the aforementioned embodiments, the determination of the power status includes accessing instructions from the computer readable medium that are executable to project a time when power to a device used by the first communicator to communicate will be limited to the extent that the communication will not be sustainable, and to indicate a power status message based at least in part on the projected time. In such cases, the power status message may indicate that power is about to be lost when the projected time for remaining power is less than a programmed amount. In some instances, the determination of the activity status includes accessing instructions from the computer readable medium that are executable to determine whether at least one of a mouse, a keyboard, and a camera indicate that the communicator is still available. In various instances, the determination of the location status includes accessing instructions from the computer readable medium that are executable to determine a location of the communicator, determine a risk of communicating from the location, and indicate the determined risk. In other instances, the determination of the location status includes accessing instructions from the computer readable medium that are executable to determine a rate of movement of the communicator, determine a risk of communicating at the rate of movement; and indicate the determined risk.

This summary provides only a general outline of some embodiments according to the present invention. Many other objects, features, advantages and other embodiments of the present invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several drawings to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 depicts an automatic status system in accordance with various embodiments of the present invention;

FIG. 2 is a flow diagram showing a method in accordance with some embodiments of the present invention for automatic status updating;

FIG. 3 is a flow diagram showing the operation of an exemplary calendar based status update that may be used in relation to an automatic status updating system in accordance with some embodiments of the present invention;

FIG. 4 is a flow diagram showing the operation of an exemplary power based status update that may be used in relation to an automatic status updating system in accordance with some embodiments of the present invention;

FIG. 5 is a flow diagram showing the operation of an exemplary activity based status update that may be used in relation to an automatic status updating system in accordance with one or more embodiments of the present invention; and

FIG. 6 is a flow diagram showing the operation of an exemplary location based status update that may be used in relation to an automatic status updating system in accordance with various embodiments of the present invention.

### DETAILED DESCRIPTION OF THE INVENTION

The present invention is related to communication systems, and more particularly to systems and methods for indicating the status of one or more communicators interacting in a communication.

Various systems and methods for indicating the status of a communication are disclosed herein. For example, some embodiments of the present invention provide Internet communication systems that include a computer readable medium maintaining instructions executable by a processor. As used herein, the phrase “computer readable medium” is used in its broadest sense to mean any media that is accessible to a processor. Thus, for example, a computer readable medium may be, but is not limited to, a hard disk drive, a random access memory, a flash memory, an optical disk, a holographic memory, a floppy disk drive, combinations of the aforementioned and/or the like. The instructions are executable by a processor to receive a first communication message directed to a communicator, and to send a second communication message from the communicator. As used herein, the terms “communication” or “communication message” are used in their broadest sense to mean any form of communication. Thus, for example, a communication or communication message may be, but is not limited to a text communication, a voice communication, a video communication, and combinations of the aforementioned. Based on the disclosure provided herein, one of ordinary skill in the art will recognize a variety of communications to which embodiments of the present invention may be applied. Further, as used herein, the term “communicator” is used in its broadest sense to mean a person, an animal, or an entity or device capable of receiving a communication and interpreting a communication status message.

The computer readable medium further includes instructions executable by the processor to determine a combination of status. As used herein, the phrase “combination of status” is used in its broadest sense to mean two or more status indications that are utilized together. In some cases, the combination of status may include a use of two or more of a calendar status, a power status, an activity status, and a location status. Based at least in part on the combination of status, a communication status message is updated. As used herein, the phrase “communication status message” is used in its broadest sense to mean any message indicating the status of a particular communication. Thus, for example, a communication status message may indicate that one communicator previously interacting in a communication is no longer available. Alternatively, such a communication status message may indicate that a previously non-participating communicator is now available and participating in an ongoing communication. Based on the disclosure provided herein, one of ordinary skill in the art will recognize a myriad of communication status messages that may be created, updated, and/or displayed in accordance with one or more embodiments of the present invention.

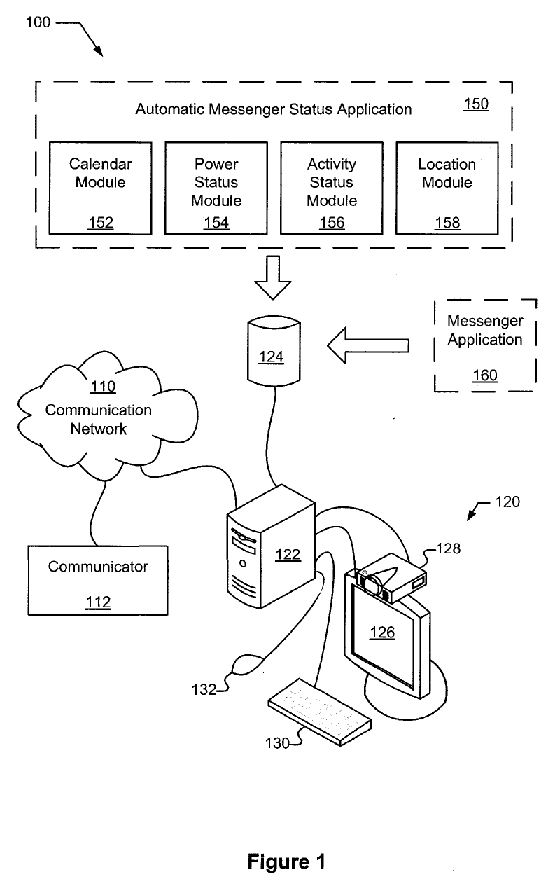

Turning to FIG. 1, an automatic status system 100 in accordance with various embodiments of the present invention is shown. Automatic status system 100 provides for indicating a communication status related to a communication ongoing between two or more communicators. One of the communicators (i.e., communicator 112) is simply identified as a box, while the other communicator is assumed to be a person operating a communication environment 120. Communication environment 120 is communicably coupled to communicator 112 via a communication network 110. Communication network 110 may be any network capable of transporting communications between communication environment 120 and communicator 112. Thus, for example, communication network 110 may be the Internet, a virtual private network, a cellular network, a WiFi network, an optical network, combinations of the aforementioned and/or the like.

Communication environment 120 may be any environment that allows a communicator to receive communications directed to them, and to send communications directed to another communicator. Thus, for example, communication environment may be based on a personal computer as shown, on a laptop computer, on a personal digital assistant, on a cellular telephone, or the like. In the depicted example, communication environment 120 includes a computer 122 with a processor. Computer 122 is communicably coupled to various input/output devices including a camera 128, a keyboard 130 and a mouse 132. As used herein, the phrase “communicably coupled” is used in its broadest sense to mean any coupling whereby information may be transferred between two devices. Thus, for example, two devices may be communicably coupled by a wire or optical fiber extending between the devices, or via a wireless medium operating between the two devices. Based on the disclosure provided herein, one of ordinary skill in the art will recognize a variety of approaches and mechanisms that may be used to communicably couple two devices in accordance with one or more embodiments of the present invention.

Further, computer 122 is communicably coupled to a computer readable medium 124. Computer readable medium 124 may be either in part or in whole integrated or apart from computer 122. Computer readable medium includes various instructions that are executable by the processor of computer 122. Such instructions may be, for example, in the form of software or firmware applications. Such instructions may be formed into a messenger application 160, and an automatic messenger status application 150. Messenger application 160 may be any communication application that provides for sending and receiving messages between communicators. Thus, for example, messenger application 160 may be, but is not limited to, a commercially available Internet messenger (i.e., instant messenger). In some cases, automatic messenger status application 150 is integrated with a commercially available Internet messenger.

Automatic messenger status application 150 may include one of a number of status modules that may be used in combination to determine the status of a communicator interacting with messenger application 160. As shown, automatic messenger status application 150 includes a calendar module 152, a power status module 154, an activity status module 156 and a location module 158. Calendar module 152 is operable to determine whether a communication interruption was due to a scheduling conflict of a communicator using communication environment 120, or whether an ongoing communication may conflict with an upcoming scheduled event of the communicator using communication environment 120. Power status module 154 is operable to determine whether a communication interruption was due to a loss of power to communication environment 120, or whether an ongoing communication may be impacted by an impending loss of power to communication environment 120. Activity status module 156 is operable to probe various input/output devices associated with communication environment 120 to determine whether the communicator using communication environment 120 may have stepped away or is still actively using communication environment 120. Location module 158 is operable to determine the location and/or movement of communication environment 120, and to determine if the location and/or movement represents some risk to an ongoing communication.

Automatic messenger status application 150 receives status from two or more of the aforementioned modules and from that forms a combined communication status. This combined communication status is impacted by programmable constraints on the type and level of messages that are desired as communication status messages. The combined communication status is used by automatic messenger status application 150 to post a status message indicating the availability or other status of a communicator using communication environment 120. Such a communication status message may be, but is not limited to, an indication that the communicator is no longer using communication environment 120, that the communicator is still using communication environment 120, that the communication may be lost due to a loss of power, that the communicator using communication environment 120 has an upcoming meeting, that the communicator using communication environment 120 likely stepped away to attend a meeting that is scheduled to end at a particular time, that the communication may be interrupted due to a location or movement of communication environment 120. Based on the disclosure provided herein, one of ordinary skill in the art will recognize a variety of communication status messages that may be generated by automatic messenger status application 150 in accordance with one of more embodiments of the present invention. The communication status message may be provided to communicator 112 or other communicators interacting in a given communication via communication network 110.

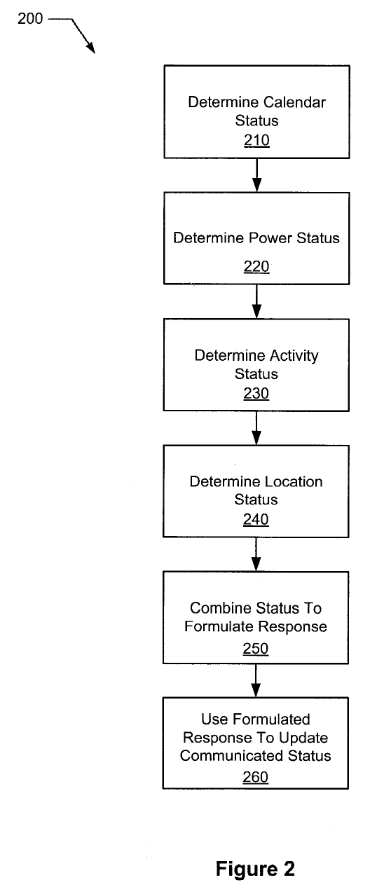

Turning to FIG. 2, a flow diagram 200 depicts a method in accordance with some embodiments of the present invention for automatic status updating. Following flow diagram 200, a number of status are determined (blocks 210-240). In particular, a calendar status is determined (block 210), a power status is determined (block 220), an activity status is determined (block 230) and a location status is determined (block 240). In some cases, determination of the aforementioned calendar status (block 210) includes accessing an electronic calendar that indicates a schedule of one of the communicators, and identifying an event on the calendar that conflicts with the communication. Thus, for example, while a communication is ongoing between two or more communicators, the electronic calendar for one of the communicators may be polled. Where it is determined that the communicator has a meeting in the near future, a status may be generated indicating that there is an upcoming potential conflict with the communication. Based on the disclosure provided herein, one of ordinary skill in the art will recognize a variety of calendar status conflicts and associated messages that may be detected and reported in accordance with embodiments of the present invention.

In some cases, determination of the aforementioned power status (block 220) includes accessing power information associated with a device or system used by a communicator to continue with an ongoing communication. This information is used to project a time in the future when the power available may not be sufficient to maintain the current communication. Where the time remaining is sufficiently low, a message indicating the potential loss of power is generated. Thus, for example, where a communicator is using a laptop computer to facilitate an ongoing communication and it is determined that the laptop has less than fifteen minutes of battery life remaining, a message indicating the limited remaining battery life may be generated. Based on the disclosure provided herein, one of ordinary skill in the art will recognize a variety of power status conflicts and associated messages that may be detected and reported in accordance with various embodiments of the present invention.

In various cases, determination of the aforementioned activity status (block 230) includes accessing one or more IO associated with a device used to perform an ongoing communication to determine if the communicator using the device is still available. Thus, for example, it may be determined if the keyboard, mouse, or webcam show any activity. Where none of the aforementioned show any activity, a message indicating the lack of activity may be generated. It should be noted that any IO or combination of IO demonstrating may be used in accordance with different embodiments of the present invention. Thus, for example, it may be that activity is solely based on information received from a webcam, or it may be that activity is based on the combination of information from a webcam and that from a keyboard. Based on the disclosure provided herein, one of ordinary skill in the art will recognize a variety of IO and combinations thereof that may be used to determine if a communicator is still operating a device used in a communication in accordance with one or more embodiments of the present invention.

In various cases, determination of the aforementioned location status (block 240) includes determining a location or rate of movement of a device used by a communicator to facilitate an ongoing communication, and to determine a risk associated with the location or rate of movement. For example, where the device is moving very rapidly, it may be more likely that communications will be lost. Alternatively, or in addition, where the device is at a location other than a known location, it may be decided that there is a greater likelihood that a communication may be lost. In some cases, determination of location and movement is done based on a GPS receiver integrated with one or more devices used by a communicator to facilitate an ongoing communication. Based on the disclosure provided herein, one of ordinary skill in the art will recognize a variety of devices and methods for determining location and/or movement that may be used in relation to one or more embodiments of the present invention. Further, based on the disclosure provided herein, one of ordinary skill in the art will recognize a variety of methods for assigning risk to movement and location information, and a variety of messages that may be used to report such risk in accordance with various embodiments of the present invention.

Status messages received from one or more of the status monitors are combined to formulate a response (block 250). Formulating the response may include selecting one or more relevant status messages and combining the messages into a single unified response. Thus, for example where power loss is imminent, but all other status look fine, a formulated response may indicate that power may be lost soon. Such an approach considers messages (or lack thereof) from the various status monitors and results in reporting only a single status message. Thus, a combination of status is determined and used for formulate a response. Alternatively, where power is about to be lost and the activity monitor indicates that the communicator has stepped away from the device being used to facilitate the communications, a compound message indicating both of the status may be formulated. Such an approach considers messages (or lack thereof) from the various status monitors and results in reporting a compound status message. Again, a combination of status is determined and used for formulate a response.

The formulated message is then updated as a communication status (block 260). Such a communication status is posted or otherwise communicated such that one or more communicators associated with an ongoing communication have access to the message. Thus, for example, in the case of an Internet messenger service, a party on the other end of the Internet messenger communication may be made aware of a potential communication conflict occurring with a communicator with whom they are communicating. In this way, misunderstandings may be avoided where communications are lost. Based on the disclosure provided herein, one of ordinary skill in the art will recognize a variety of communications and communication media to which the approaches discussed herein may be applied. Further, based on the selected communication media, one of ordinary skill in the art will recognize a variety of approaches for providing the communicated status to other communicators involved in an ongoing communication.

It should be noted that some subset of calendar status, power status, activity status and location status may be used in accordance with different embodiments of the present invention. For example, it may be that only calendar status and power status may be utilized. As yet another example, it may be that all of the status may be used except location status. Based on the disclosure provided herein one of ordinary skill in the art will recognize a number of status combinations that may be used depending upon calendar, power, IO, and location information availability and the perceived need for the different status input.

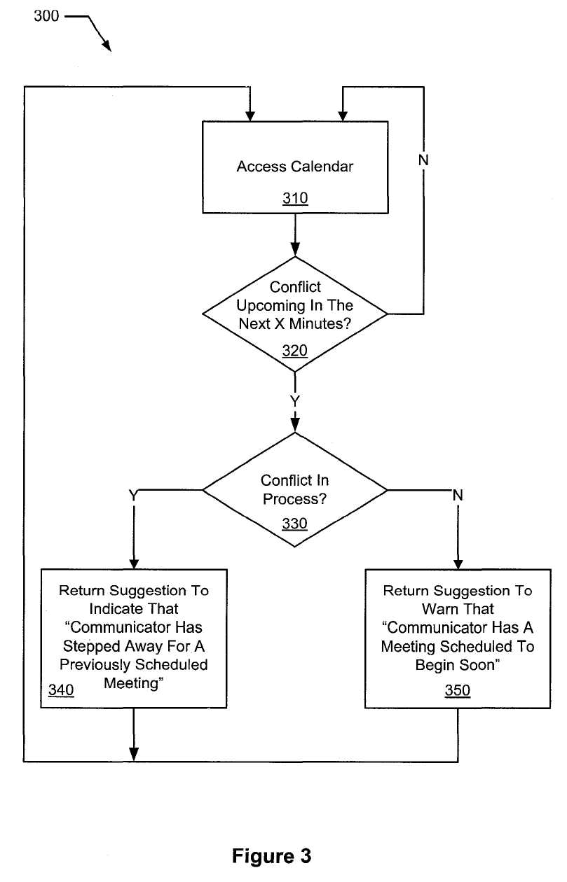

Turning to FIG. 3, a flow diagram 300 shows the operation of an exemplary calendar based status update that may be used in relation to an automatic status updating system in accordance with some embodiments of the present invention. Following flow diagram 300, an electronic calendar is accessed (block 310). The information retrieved from the electronic calendar is used to determine if a scheduling conflict is upcoming in the next X minutes (block 320). In some cases, the time threshold, X, is programmable, while in other cases it is hard coded at a predefined value. Where a conflict is not within X minutes (block 320), no message is generated. Alternatively, where a conflict is upcoming in the next X minutes (block 320), it is determined if the identified conflict is already in process or is just upcoming (block 330). Where the conflict is upcoming (block 330), a message indicating that the communicator has a meeting scheduled to begin soon (block 350). Alternatively, where the conflict is already in process (block 330), a message indicating that the communicator has stepped away for a previously scheduled meeting (block 340). Based on the disclosure provided herein, one of ordinary skill in the art will recognize a variety of messages and time thresholds that may be used in accordance with embodiments of the present invention. It should be noted that various information from the calendar may be provided as part of any message to another communicator. For example, the start and end time of a meeting identified on the calendar may be made available. As another example, the location of the meeting may be made available. Of course, some privacy issues would need to be considered as some communicators would not want to let other communicators know more than just the most rudimentary details of a communicator's status. Further, in some cases the next meeting time is provided to another communicator even if the next meeting time is well into the future.

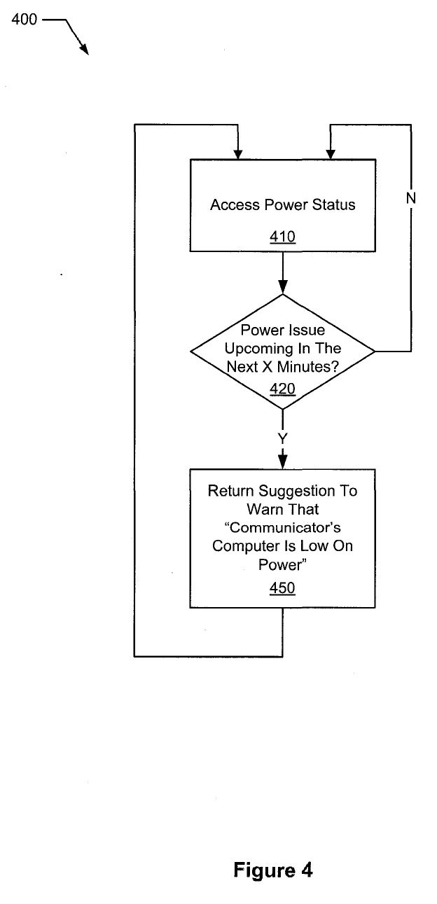

Turning to FIG. 4, a flow diagram 400 shows the operation of an exemplary power based status update that may be used in relation to an automatic status updating system in accordance with some embodiments of the present invention. Following flow diagram 400, a power status is accessed (block 410). Such a power status may be a power monitor tool integrated with a device being used to facilitate a communication. Thus, for example, the power status may be a power monitor tool integrated with a cellular telephone or a laptop computer. The information retrieved from the power monitor tool is used to determine if power will be exhausted in the next X minutes (block 420). In some cases, the time threshold, X, is programmable, while in other cases it is hard coded at a predefined value. Where a conflict is not within X minutes (block 420), no message is generated. Alternatively, where a conflict is upcoming in the next X minutes (block 420), a message is generated indicating that a loss of power may occur in the near future (block 450). Based on the disclosure provided herein, one of ordinary skill in the art will recognize a variety of messages and time thresholds that may be used in accordance with embodiments of the present invention. Where power is derived from a power outlet, that may be messaged to another communicator, or the battery charging level or remaining battery life may be made available.

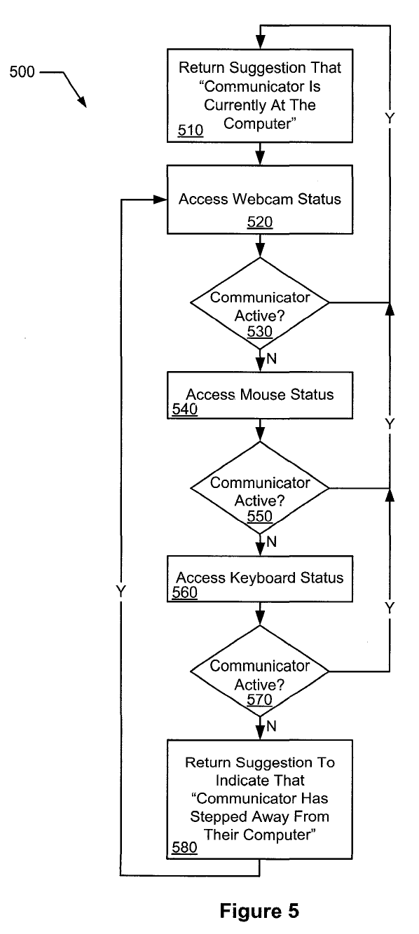

Turning to FIG. 5, a flow diagram 500 shows the operation of an exemplary activity based status update that may be used in relation to an automatic status updating system in accordance with one or more embodiments of the present invention. Following flow diagram 500, a webcam is accessed to determine whether the view of a communicator using the device has been updated (block 520). This may include determining whether an image captured by a webcam has changed within a predetermined period of time. Where the view has been updated (block 530), it is determined that the communicator is still active. Alternatively, where the view has not been updated (block 530) it is possible that the communicator using the device is no longer in proximity of the device. A mouse status is then accessed to see how long it has been since input has been received via the mouse (block 540). Where the mouse was recently used (block 550), it is determined that the communicator is still active. Alternatively, where the mouse has not been recently used (block 550) it is possible that the communicator using the device is no longer in proximity of the device. A keyboard status is then accessed to see how long it has been since input has been received via the keyboard (block 560). Where the keyboard was recently used (block 570), it is determined that the communicator is still active. Alternatively, where the keyboard has not been recently used (block 570) it is possible that the communicator using the device is no longer in proximity of the device.

Where it is determined from the webcam, mouse and keyboard that no activity is available (blocks 530, 550, 570), a message indicating that the communicator has stepped away or otherwise become inactive is returned (block 580). It should be noted that use of all three of the keyboard, mouse and webcam is merely exemplary, and that in one or more embodiments of the present invention some subset of the aforementioned IO, or other IO may be used to determine the activity status of a communicator in accordance with one or more embodiments of the present invention.

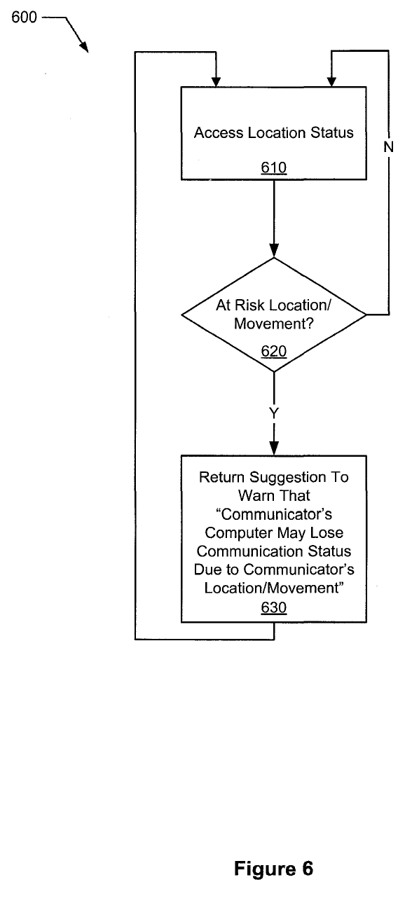

Turning to FIG. 6 is a flow diagram 600 shows the operation of an exemplary location based status update that may be used in relation to an automatic status updating system in accordance with various embodiments of the present invention. Following flow diagram 600, a location status is accessed (block 610). This may include, for example, accessing a GPS receiver integrated with a device being used to facilitate an ongoing communication. From this information, the location of the device and/or a rate at which the device is moving is/are determined. It is then determined if the location information suggests any potential complication to an ongoing communication (block 620). This may include making a determination that any movement of the device may be a potential problem, or that movement greater than a particular rate may be a potential problem. Alternatively, or in addition, this may involve comparing the location of the device to a number of known locations such as a communicator's home address and a communicator's office address. Where the location is not a known location a potential communication problem may be indicated. Based on the disclosure provided herein, one of ordinary skill in the art will recognize a variety of other location based concerns that may be queried and flagged in accordance with various embodiments of the present invention. Where a risk is indicated (block 620), a message is returned indicating that the ongoing communication may be interrupted due to the location and/or movement of the communicator. In some cases, the actual location is provided to other communicators. In other cases, the type of location is provided to another communicator. This may include indicating that the communicator is on a freeway, in a mall, or at a residence. Further, the speed at which a communicator is moving may be provided to other communicators.

In conclusion, the present invention provides novel systems, devices, methods and arrangements related to communication status identification. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A communication status identification system, the system comprising:
a processor and a computer readable medium, wherein the computer readable medium includes instructions executable by the processor to:
initiate a communication, wherein the communication allows at least a first communicator and a second communicator to communicate;
determine a combination of status, wherein the combination of status includes a determination of at least two of a calendar status, a power status, an activity status, and a location status; and
update a communication status message, wherein the communication status message is based at least in part on the determined combination of status.

2. The system of claim 1, wherein the determination of the calendar status includes accessing instructions from the computer readable medium that are executable to:
access an electronic calendar, wherein the electronic calendar indicates a schedule of the first communicator; and
identify an event on the calendar that conflicts with the communication.

3. The system of claim 2, wherein the event is selected from a group consisting of: a present conflict, and a future conflict.

4. The system of claim 3, wherein the future conflict is identified as an event occurring within a programmed time limit in the future.

5. The system of claim 1, wherein the determination of the power status includes accessing instructions from the computer readable medium that are executable to:
project a time when power to a device used by the first communicator to communicate will be limited to the extent that the communication will not be sustainable; and
indicate a power status message based at least in part on the projected time.

6. The system of claim 5, wherein the power status message indicates that power is about to be lost, and wherein the power status is provided when the time is less than a programmed amount.

7. The system of claim 1, wherein the determination of the activity status includes accessing instructions from the computer readable medium that are executable to:
determine whether at least one of a mouse, a keyboard, and a camera indicate that the communicator is still available.

8. The system of claim 1, wherein the determination of the location status includes accessing instructions from the computer readable medium that are executable to:
determine a location of the communicator;
determine a risk of communicating from the location; and
indicate the determined risk.

9. The system of claim 1, wherein the determination of the location status includes accessing instructions from the computer readable medium that are executable to:
determine a rate of movement of the communicator;
determine a risk of communicating at the rate of movement; and
indicate the determined risk.

10. The system of claim 1, wherein determining the combination of status includes a determination of at least three of the calendar status, the power status, the activity status, and the location status.

11. The system of claim 1, wherein determining the combination of status includes a determination of all of the calendar status, the power status, the activity status, and the location status.

12. A method for indicating communication status, the method comprising:
initiating a communication, wherein the communication allows at least a first communicator and a second communicator to communicate;
determining a combination of status, wherein the combination of status includes a determination of at least two of a calendar status, a power status, an activity status, and a location status; and
updating a communication status message, wherein the communication status message is based at least in part on the determined combination of status.

13. The method of claim 12, wherein determining the combination of status includes a determination of at least three of the calendar status, the power status, the activity status, and the location status.

14. The method of claim 12, wherein determining the combination of status includes a determination of all of the calendar status, the power status, the activity status, and the location status.

15. The method of claim 13, wherein:
the determination of the calendar status includes:
accessing an electronic calendar, wherein the electronic calendar indicates a schedule of the first communicator; and
identifying an event on the calendar that conflicts with the communication;
the determination of the power status includes:
projecting a time when power to a device used by the first communicator to communicate will be limited to the extent that the communication will not be sustainable; and
indicating a power status based at least in part on the projected time; and
the determination of the activity status includes:
determining whether at least one of a mouse, a keyboard, and a camera indicate that the communicator is still available.

16. An Internet communication system, the system comprising:
a computer readable medium, wherein the computer readable medium includes instructions executable by a processor to:
receive a first communication message directed to a communicator,
send a second communication message from the communicator;
determine a combination of status, wherein the combination of status includes a determination of at least two of a calendar status, a power status, an activity status, and a location status; and
update a communication status message, wherein the communication status message is based at least in part on the determined combination of status.

17. The system of claim 16, wherein the first communication message is selected from a group consisting of: text, voice, and video.

18. The system of claim 16, wherein the communicator is a first communicator, wherein the second communication message is directed to a second communicator, and wherein the communication status message is visible to the second communicator.

19. The system of claim 16, wherein determining the combination of status includes a determination of at least three of the calendar status, the power status, the activity status, and the location status.

20. The system of claim 16, wherein determining the combination of status includes a determination of all of the calendar status, the power status, the activity status, and the location status.
